(19) United States
(12) Patent Application Publication
(10) Pub. No.: US 2023/0242443 A1
(43) Pub. Date: Aug. 3, 2023

(54) Cellulose-Based Structural Webbing for Spray-On Applications

(71) Applicant: Builderscrete, Inc., Lake Charles, LA (US)

(72) Inventor: Joshua Allen McGuire, Lake Charles, LA (US)

(21) Appl. No.: 18/131,351

(22) Filed: Apr. 5, 2023

Related U.S. Application Data
(63) Continuation-in-part of application No. 17/100,470, filed on Nov. 20, 2020.
Application No. 17/100,470 is a continuation-in-part of application No. 16/583,200, filed on Sep. 25, 2019.
(60) Provisional application No. 62/938,874, filed on Nov. 21, 2019.
(60) Provisional application No. 62/739,209, filed on Sep. 29, 2018.
(60) Provisional application No. 62/775,384, filed on Dec. 4, 2018.
(60) Provisional application No. 62/806,974, filed on Feb. 18, 2019.

(51) Int. Cl. C04B 16/02; C04B 16/06; C04B 18/26; C04B 14/10; C04B 20/10

(52) U.S. Cl. CPC C04B 16/02; C04B 16/06; C04B 18/26; C04B 14/10; C04B 20/1081; C04B 2111/28

(57) ABSTRACT

What is disclosed is a cellulose-based product and a method for producing the aggregate admix product that includes the steps of thoroughly hydrating cellulose fibers, mixing clay and mineral particulates with a liquid to produce an emulsion, adding the emulsion to the hydrated cellulose fibers, and thoroughly impregnating the cellulose fibers with components from the emulsion and producing an aggregate admix product. The aggregate admix product is combined with cement and a liquid to create a cementitious product that can be directly sprayed onto building structures.

### RELATED APPLICATIONS

The present application is a continuation-in-part of U.S. patent application Ser. No. 17/100,470 entitled “Cellulose-Based Aggregate Admix” filed on Nov. 20, 2020, which claims the benefit of U.S. Provisional Patent Application No. 62/938,874 filed on Nov. 21, 2019. This application is also a continuation-in-part application of U.S. patent application Ser. No. 16/583,200 filed Sep. 25, 2019 entitled “Novel Cellulose-Based Admix and Processes for Fabricating a Lightweight Concrete Substitute and Building Components for Construction,” which claims the benefit of U.S. Provisional Patent Application No. 62/739,209 filed on Sep. 29, 2018, U.S. Provisional Patent Application No. 62/775,384 filed Dec. 4, 2019 and U.S. Provisional Patent Application No. 62/806,974 filed on Feb. 18, 2010. All of the aforementioned priority patent applications are incorporated herein by reference.

### FIELD

The present disclosure relates generally to construction materials and fabrication processes, and in particular to a cellulose-based structural webbing material for spray-on applications to create a fireproof insulative structural-reinforcing cementitious webbing envelope around building structures.

### BRIEF DESCRIPTION OF THE DRAWINGS

FIGS. 1-5 are flowcharts of various embodiments of a manufacturing process for a cellulose-based aggregate admix product according to the teachings of the present disclosure;

FIG. 6 is a flowchart of an exemplary manufacturing process for a concrete product incorporating a cellulose-based aggregate admix product according to the teachings of the present disclosure; and

FIG. 7 is a flowchart of an exemplary manufacturing process for a spray on application of a cellulose-based structural webbing material incorporating a cellulose-based aggregate admix product according to the teachings of the present disclosure.

### BACKGROUND

Cement is typically sold to the average consumer in 50-90 pound bags. For many consumers, the bulk and weight of these bags of cement is simply unmanageable or even impossible to work with. Further, in order to use the cement, it has to be mixed with gravel, sand, water, and other materials, and then poured into a mold or form that has to be prefabricated or made on-site. It is also desirable to use a building material that is stronger, more impact-resistant, thermally insulative, fire-retardant, and environmentally sound.

### DETAILED DESCRIPTION

A lightweight recycled cellulose-based aggregate admix described herein can be utilized in conjunction with Portland cement products to fabricate thermally insulative and fire-retardant building components, including bricks, blocks, boards, siding, panels (i.e., oriented strand board and plywood substitutes), posts, columns, beams, and other types of structural and non-structural components and supports. This process not only yields lightweight insulative, fire-proof, and anti-ballistic construction components but also substantially reduces costs and offset the carbon footprint of a construction project. For every two pounds of wood byproduct that is incorporated into the admix, approximately one pound of carbon is removed from the atmosphere and sequestered.

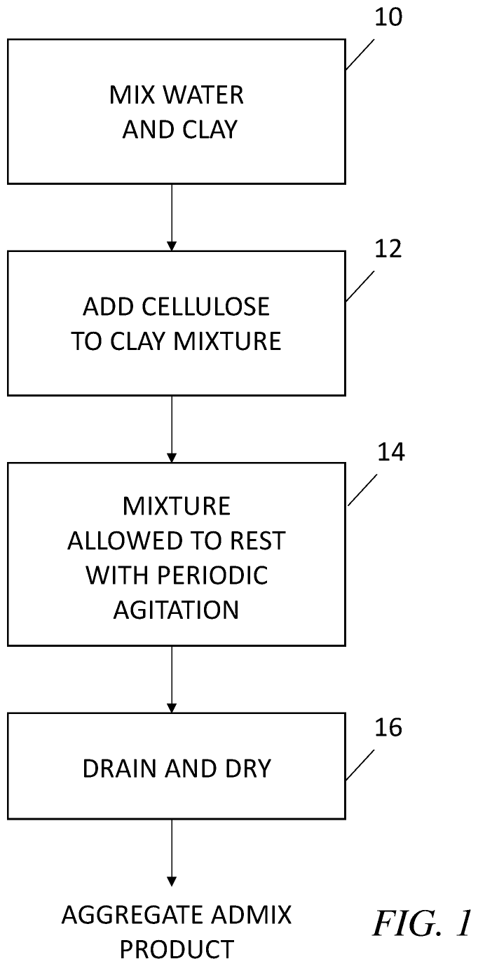

FIG. 1 is a simplified flowchart of a manufacturing process for a cellulose-based admix and aggregate product that is used to fabricate the building blocks described herein. The lightweight admix and aggregate can be made by first combining by folding and mixing a light fine clay, and water (at a certain predetermined temperature) as shown in block 10. This clay mixture is then combined with an organic cellulose material of certain sizes that can be as small as microscopic particles and as large as an entire tree (the size can depend on the intended application and the size of applicator tools, such as no larger than one inch), including sawdust, wood chips, wood flakes, wood strips, fiber, bamboo, hemp, burlap, tweed, organic waste, and animal waste both liquid and solid form, as shown in block 12. The ratios of the three main components (cellulose material, water, and fine clay) can be varied dependent on the desired characteristics of the final product. Saw dust is a desirable material to use as it is a waste product of the lumber industry. Green cellulose can be air dried or dried with an application of heat (e.g., in a kiln) to remove excess moisture. The cellulose, clay, and water can be mixed together using a paddle mixer to ensure that the cellulose is well-hydrated, the clay particles are well-dispersed in the mixture (emulsification), and the cellulose fibers are well-coated with the clay emulsification. Alternatively, the clay, water, and sawdust/cellulose can be added and combined at the same time. This causes the fine clay particles and minerals present in the clay to be impregnated in the cellulose, filling all voids between the fibers and particles. The cellulose-water-clay mixture is then allowed to stand, with periodic mixing or agitation, for a time period, such as a number of hours, as shown in block 14. Then the mixture is poured out and evenly spread over a flat and water permeable surface that allows moisture to be drained and removed from the cellulose-clay mixture, as shown in block 16. A tumbling barrel with water-permeable sides may be used to remove the moisture, with or without added heat and/or air movement. The treated cellulose can be air dried this way, or an application of heat at a certain temperature with or without forced air and/or vacuum may be used to speed up the process. The amount of clay present in the mixture can be increased to increase the compressive strength, depending on the desired characteristics of the end product. The dried cellulose-based admix is composed of cellulose thoroughly coated and impregnated with fine clay particles and minerals. The result is an admix product that can be used in cement mixtures that produces a lightweight but strong construction material.

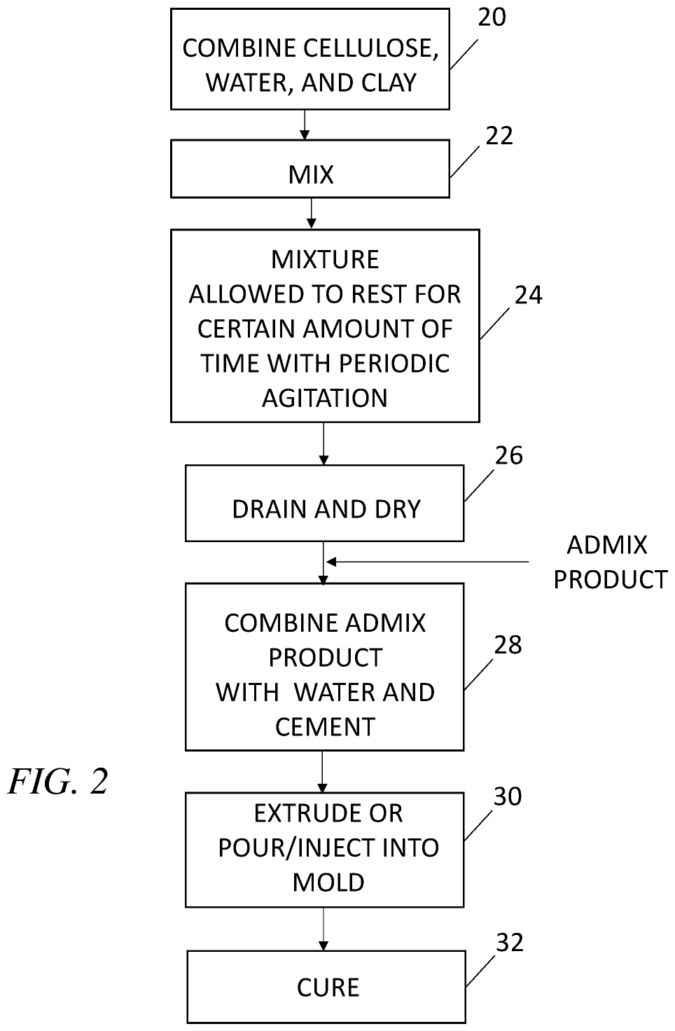

Referring to FIG. 2, an alternative manufacturing process mixes cellulose, clay, and water at a predetermined ratio and temperature, as shown in blocks 20 and 22. The mixture is then allowed to soak and rest, with periodic agitation, as shown in block 24. The mixture is then allowed to drain and be dried, as shown in block 26. Heat, forced air circulation, and/or vacuum may be used during the drying process. This admix product may then be mixed or combined with water and cement and extruded, injected, or molded into the final product and cured, as shown in blocks 28-32.

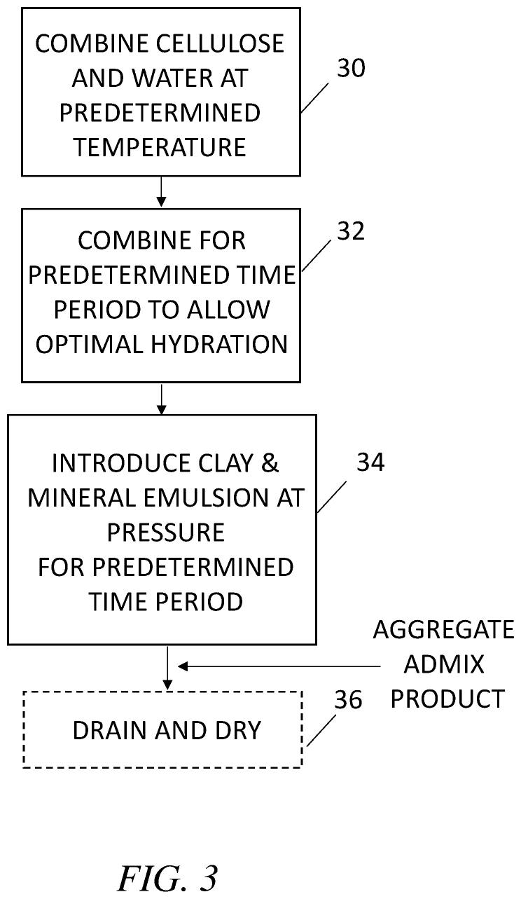

Referring to FIG. 3, another exemplary process preferably employs ten-minute time increments to allow dry fiber to absorb warm water (or another liquid) to begin a “flushing” process of the cellulose fiber, as shown in blocks 30 and 32. Within one or more ten-minute time periods the fiber is capable of absorbing 2-3 times its own weight. This time period of ten minutes is not a rule but a guideline allowing for optimal production times in a large-scale manufacturing environment. Once optimal hydration has been reached, a clay and mineral emulsion is introduced, as shown in block 34. The already hydrated fiber is placed in a pump chamber. At this point the clay emulsification is introduced into the pressure chamber. The goal is to introduce the clay emulsion to the hydrated cellulose at pressure. The duration of exposure to the clay emulsion under the pressure of the pump has a direct correlation to the level of penetration (coating/impregnation/stacking) of clay particulate/sediment into the cellulose fibers. The duration and pressure upon the fiber may be modified to allow for different aggregate admix performance characteristics and different levels of fiber density. Once this process is completed the result is the aggregate admix product, which may be immediately utilized as an ingredient in the production of concrete. The processed fiber, now in aggregate/admix form, may optionally be air/machine dried and bagged or placed in silos or shipping containers to allow for easier transport and distribution, as shown in block 36. The finished aggregate admix product is ready to be utilized in standard production equipment and machinery with little to no modifications necessary to existing production and finishing equipment to allow for the production of finished concrete with enhanced working characteristics and environmentally friendly reduced carbon dioxide products.

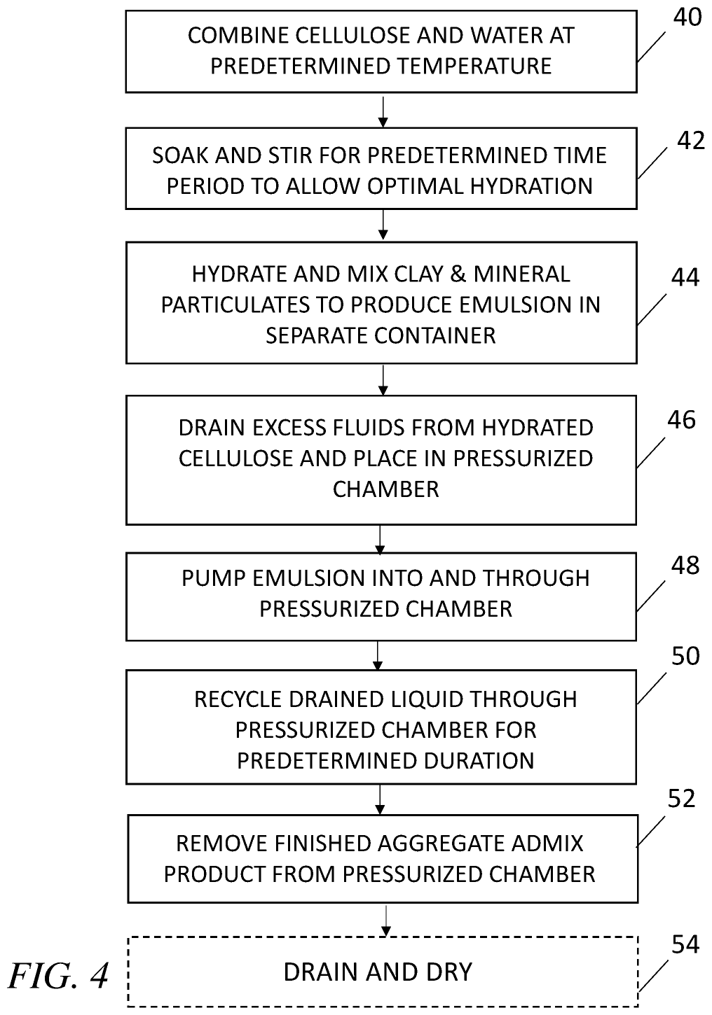

Referring to FIG. 4, yet another exemplary process begins with optimally soaking the cellulose/fiber/sawdust using a liquid such as water at a predetermined temperature, as shown in blocks 40 and 42. In a separate container, a clay and mineral particulate mixture is hydrated and mixed to produce an emulsion, as shown in block 44. Once fiber optimal hydration has been reached and the swollen fiber has been flushed of the sugar or sap, excess liquids are drained and the hydrated fibers are placed in a pressurized chamber, as shown in block 46. The clay/mineral emulsification is then introduced by pumping it into and through the pressurized chamber, as shown in block 48. The liquid that drains from the pressurized chamber is recycled back through the chamber, as shown in block 50. The duration that the fibers are exposed to the emulsion along with the pressures of pressurized chamber has a direct correlation to the level of penetration (coating/impregnation/stacking) of clay particulate/sediment into the cellulose fiber. The duration and pump pressure upon the fiber may be modified to allow for different aggregate admix performance characteristics and different levels of fiber density. Once this impregnation process is completed the result is the aggregate admix product, which may be removed and immediately utilized as an ingredient in the production of concrete, as shown in block 52. The processed fiber, now in aggregate admix form, may optionally be air/machine dried and bagged or placed in silos or shipping containers to allow for easier transport and distribution, as shown in block 54. The finished aggregate admix product is ready to be utilized in standard production equipment and machinery with little to no modifications necessary to existing production and finishing equipment to allow for the production of finished concrete with enhanced working characteristics and environmentally friendly reduced carbon dioxide products.

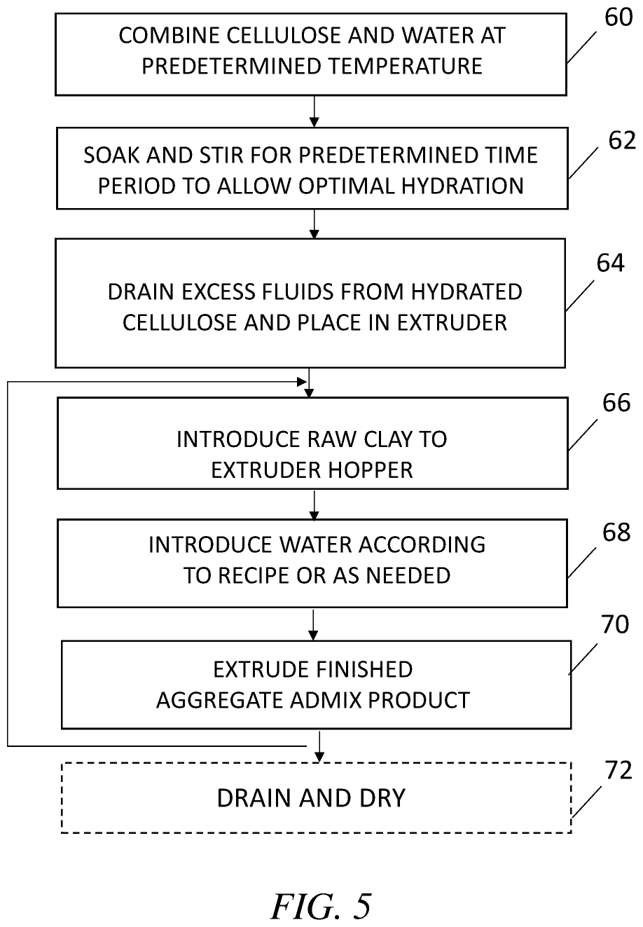

FIG. 5 is a flowchart of another exemplary process that begins with optimally soaking, mixing, and stirring the cellulose/fiber/sawdust with a liquid such as water at a predetermined temperature, as shown in blocks 60 and 62. Once fiber optimal hydration has been reached and the swollen fiber has been flushed of the sugar or sap, excess liquids are drained and the hydrated fibers are placed in an extruder without a shaping head, as shown in block 64. A raw clay is then introduced by introducing it into the extruder, as shown in block 66. Raw clay is clay that has not been processed so that it retains its natural properties. Additional liquids or water may be added according to the recipe or as needed, shown in block 68. The duration and pressure upon the fiber may be modified to allow for different aggregate admix performance characteristics and different levels of fiber density. This extrusion process may be repeated to achieve thorough coating and impregnation of the cellulose fibers. Once this coating and impregnation process is completed the result is the aggregate admix product, which may be removed and immediately utilized as an ingredient in the production of concrete, as shown in block 70. The processed fiber, now in aggregate admix form, may optionally be air/machine dried and bagged or placed in silos or shipping containers to allow for easier transport and distribution, as shown in block 72. The finished aggregate admix product is ready to be utilized in standard production equipment and machinery with little to no modifications necessary to existing production and finishing equipment to allow for the production of finished concrete with enhanced working characteristics and environmentally friendly products.

The level of penetration and corresponding impregnation of clay particulates into the cellulose material is in direct correlation to the clay to water ratios, the liquid temperature, the amount of soak time, the amount of vacuum or direct pressure applied in the chamber, the frequency of optional vibration during the impregnation step, and the speed at which the moisture is removed from the saturated wood product.

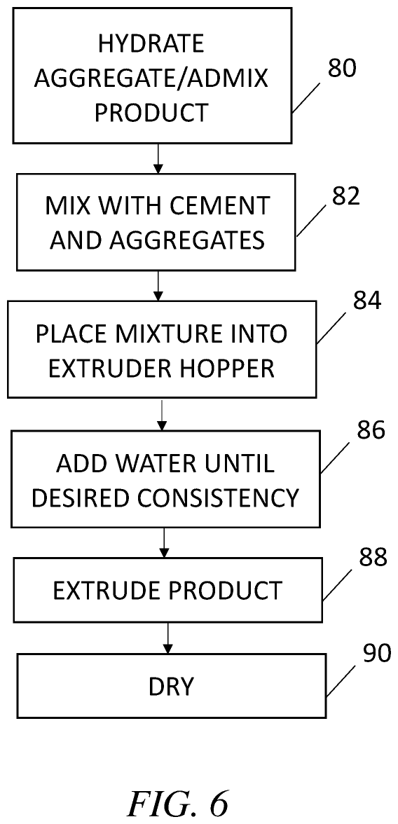

Referring to FIG. 6, a process of combining the aggregate admix product with cement is shown. In block 80, the aggregate admix product that comprises cellulose fibers impregnated with clay and mineral particles is hydrated. It is then mixed with cement and other aggregates such as sand, gravel, etc., as shown in block 82. The mixture is then poured into the hopper of an extruder, as shown in block 84, and water is added in small amounts until a specific amount of water according to a predetermined recipe is added or the desired consistency is achieved, as shown in block 86. The resultant product can be placed in molds, injected, or extruded to form a finished product such as a construction component, as shown in block 88. Alternatively, the resultant product can be air dried or mechanically dried, as shown in block 90, to be bagged for easy transport. Alternatively, the aggregate admix can be combined and thoroughly mixed with cement and other aggregates in dry form.

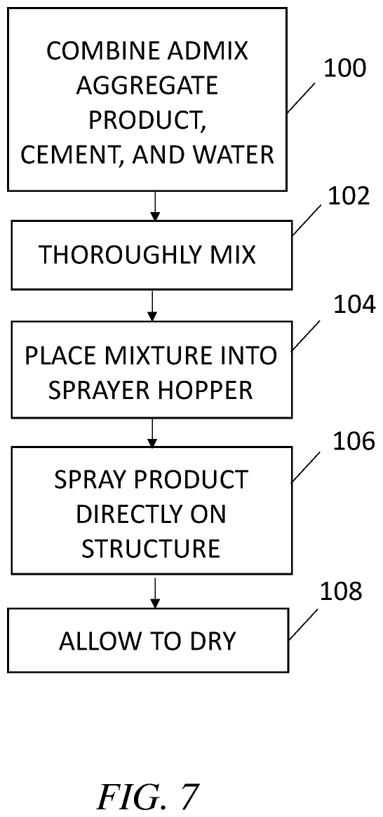

Referring to FIG. 7, a process of using the aggregate admix product for a spray-on application is shown. In block 100, the aggregate admix product that comprises cellulose fibers impregnated with clay and mineral particles and aggregate is combined with cement and water (can be any suitable liquid). An example of the material ratio is six cups of admix product, one pound of cement, and two cups of water. The ratio of these materials can be adjusted to adapt to certain applications. In an alternate embodiment, a product such as XYPEX, a crystalline expander, may be added to the mixture to achieve a non-porous waterproof end product, if desired. The materials are then thoroughly mixed to produce an activated structural webbing product, as shown in block 102. The mixture is then poured into the hopper of a sprayer, as shown in block 104. Alternatively, the activated structural webbing product can be applied using an extruder, 3-D printer, and other tools. In block 106, the activated structural webbing product is intended to be sprayed directly on the structures of a building, such as plywood, oriented strand board, and polystyrene, without the need for a housewrap liner (such as the synthetic polyethylene liner made by DU PONT marketed under the TYVEK HOMEWRAP trademark). The sprayed-on activated monolithic structural webbing is then allowed to air dry, as shown in block 108. The resultant sprayed-on mixture forms a monolithic fire-proof insulative structural-reinforcing cementitious webbing envelope around the building structure.

It is contemplated that any of the following may be packaged and sold as the end product: (1) the fine clay and mineral particulate impregnated cellulose fibers (admix product); (2) the admix product and aggregate; (3) the admix product, aggregate, water; (4) the admix product, aggregate, and cement; (5) the admix product, aggregate, cement, and water. It should be understood that the quantity of water included in the end product may be modulated to achieve different consistencies for desired applications, and that water (or other liquids) or additional water may be added to any of these end products to produce the desired mixture for use. The size of the cellulose fibers (e.g., sawdust) may be regulated for different intended applications. Further, additives described herein may be added as a component of any of the end products for desired applications. These end products can be used to create a material that can be compressed, shaped, molded, injected, extruded, sprayed, 3-D printed, and otherwise formed to fabricate fireproof and insulative structural and non-structural building components such as panels, beams, columns, posts, floors, walls, ceilings, siding, roofing tiles, molding, countertops, seawalls, etc. that possess excellent thermal insulative, sound insulative, fire-retardant, fireproof, waterproof, energy absorption, anti-ballistic, and thermal mass characteristics.

It should be understood that the general size of the cellulose fibers in the admix can be adjusted to suit the size of the sprayer nozzle opening and the desired application. It is also contemplated that a specialized sprayer tool may be used that includes a reservoir or hopper that may be used to contain, combine, and mix the cellulose-based cementitious product, with a connecting hose from the reservoir to the spray nozzle that can be used to apply the material directly onto a building structure, such as a wall, ceiling, floor, etc.

For the fabrication of fire-retardant panels or structural products, the ratio of the clay may be reduced slightly compared to the water. Optionally, excess clay may also be rinsed from the admix before the drying phase so that a cleaner surface is available for optimal bonding.

The terms cellulose, fiber, and sawdust used interchangeably herein refer to the utilization of preferably softwood species such as pine “waste” generated by the papermaking and construction industries. As the weight and density of the softwood or hardwood sawdust/cellulose/fiber structure is increased via the “impregnation/stacking” process of adding clay particulate to the body of the fiber structure, the porosity is correspondingly reduced. The more densely the fiber is “packed” with clay particulate the more likely the fiber reacts with the cement and other aggregates as sand and stone. The objective of the process described herein is to as gently as possible “impregnate” and coat the cellulose with fine clay and mineral particulate until it begins to rapidly mimic the process that naturally takes place in the petrification of wood without damaging the lignin contained in the cellulose fiber thus resulting in the ability to maintain, as best as possible, the tensile, flexural, insulation and energy absorbing qualities of wood all the while performing more similarly to a typical aggregate (e.g., sand and stone) in conjunction with a Portland based cementitious mix. During the process of impregnation/stacking the cellulose/sawdust/fiber is forced to substantially swell and this allows sugars and saps from the tree phase of life to be diluted and ultimately reduced/removed through a process of thorough rinsing and or flushing while the fiber is in the swollen state prior to the introduction of the clay emulsion. This process allows for the use of “green,” “seasoned,” or a combination of green and seasoned wood waste. After the sugars and saps are removed from the fiber structure the bond issues with Portland cement are reduced or resolved. This allows for a far better bond strength between the fiber and Portland Cement and correspondingly much higher compressive strength values in the use of the production of concrete. When working with the fiber to flush or impregnate with an emulsification, the temperature is preferably not over 150 degrees Celsius as lignin begins to decompose and breakdown at those temperatures. The temperature range should take into account of the production site elevation relative to sea level. Studies have shown that hemicellulose, cellulose, and lignin decompose over different temperature ranges, hemicellulose decomposes at a lower temperature range (220-315° C.) than cellulose (300-400° C.), while lignin decomposes over a broad range of temperatures (150-900° C.).

Additional additive materials that can be added to the admix and structural webbing product at any of the process steps, these additives include graphene, crystalline expander, carbon-based materials, sand, silt, peat, loam, chalk, fly ash, recycled paper, phosphate, lime, calcium, magnesium, sugars, lignin, vegetable and animal proteins, almond flour, coconut flour, buckwheat flour, teff flour, quinoa flour, corn flour, wheat flour, barley flour, rice flour, rye flour, tree sap, syrup, sugars, tars, nut shells and husks, corn husks, grass clippings, any by product from the production of rice, wheat, and other grain, ethylene glycol derivatives, ionic water, salt, acids, alkaline, alcohol, isopropyl alcohol, bleach, and biodegradable surfactants (including H2). These materials can also be added to the admix, silica/sand, and cement, and water to fabricate the end product used in construction, either poured into forms, molds, extruded, injected, or poured on- or off-site. The aggregate/admix described herein can be bagged and sold separately, or be combined with silica/sand and cement to be bagged as a dry mix that can be mixed with water on-site.

The lightweight cellulose-based aggregate and admix can be combined with cement and water and compressed, shaped, molded, injected, extruded, sprayed, 3-D printed, and otherwise formed to fabricate fireproof and insulative structural and non-structural building components such as panels, beams, columns, posts, floors, walls, ceilings, siding, roofing tiles, molding, countertops, seawalls, etc. that possess excellent thermal insulative, sound insulative, fire-retardant, fireproof, energy absorption, anti-ballistic, and thermal mass characteristics.

The ingredient ratios and mix composition as well as the process can be varied and modified to develop specific attributes to be utilized in a broad spectrum of end product requirements ranging from but not limited to, thermal insulative, explosive energy absorption, ballistic resistance (HESCO Alternative), acoustical improvement (sound deadening), fire retardant abilities, severe and catastrophic weather events, energy absorbing ability (highway barriers), waterproofing attributes and abilities, extreme termite resistance, the ability to entomb carbon forming a carbon trap with tremendous ecological benefit, load bearing semi-flexible wall and roof systems, lightweight waterproof impact resistant roofing tile and systems, monolithic slabs, modular floating interlocking slab systems, interlocking block and brick wall systems, landscaping products with added benefits to plant life, lightweight recycled bagged concrete alternative to heavy traditional concrete premix bags. The admix product may be used in both wet cast, dry cast, and extrusion formats and methods.

The present disclosure describes a cellulose-based aggregate admix product that may be used to produce a lightweight building block or construction component (structural or non-structural) that can be used to construct 2-D and 3-D structures wherever conventional concrete is used and more, including, for example, siding, wall panels, decorative molding, garden bed edging, raised garden beds, pavers, walkways, fire rings and fire pits, steps, low walls, retaining wall systems, structural wall systems, roofing tile systems, drainage and culvert systems, driveway, roadway systems, highway barrier systems, parking lot curb and bump systems, foundation systems (footing and slab), DIY tornado and hurricane shelters, Hesco barrier military applications (highly blast and projectile resistant), flood barrier fencing applications, fireplaces, and chimneys. The resultant structure built from this cellulose-based aggregate admix would possess improved properties over one constructed of conventional concrete. The resultant structure can withstand high temperatures and is fire-resistant, blast-resistant, projectile-resistant, impact-resistant, sound-proof, and thermally-insulative. The building component fabricated from the cellulose-based aggregate admix is also impervious to termites and rot. Because of the incorporation of cellulose, a waste product produced typically from lumber processing, the use of this construction building component is environment-friendly and can be used to offset the carbon footprint or emissions. For every two pounds of wood byproduct that is incorporated into the admix, one pound of carbon is permanently removed from the atmosphere and sequestered. The use of these building components also results in cost-savings for the overall construction project.

The features of the present invention which are believed to be novel are set forth below with particularity in the appended claims. However, modifications, variations, and changes to the exemplary embodiments of the cellulose-based aggregate admix that may be used to fabricate building components and structural and non-structural members described above will be apparent to those skilled in the art, and the described herein thus encompasses such modifications, variations, and changes and are not limited to the specific embodiments described herein.

What is claimed is:

1. A cellulose-based structural webbing mixture for spray-on applications, comprising sawdust thoroughly coated and impregnated with fine clay and mineral particulates, aggregate, cement, and water to be directly sprayed on building structures to create a monolithic fire-proof insulative structural-reinforcing cementitious webbing envelope around building structures.

2. The cellulose-based monolithic structural webbing mixture of claim 1, wherein the sawdust is thoroughly coated and impregnated with fine clay and mineral particulates by injecting an emulsion of fine clay and mineral particulates into a pressurized chamber containing hydrated cellulose fibers.

3. The cellulose-based monolithic structural webbing mixture of claim 1, wherein the sawdust is thoroughly coated and impregnated with fine clay and mineral particulates by forcing raw clay particulates into hydrated cellulose fibers.

4. The cellulose-based monolithic structural webbing mixture of claim 1, wherein the activated structural webbing mixture further comprises cellulose fibers selected from the group consisting of wood chips, wood flakes, wood strips, fiber, bamboo, hemp, burlap, tweed, organic waste, and animal waste.

5. The cellulose-based monolithic structural webbing mixture of claim 1, wherein the activated structural webbing mixture further comprises an additive is selected from the group consisting of sand, gravel, graphene, crystalline expander, carbon-based materials, silt, peat, loam, chalk, fly ash, recycled paper, phosphate, lime, calcium, magnesium, sugars, lignin, vegetable and animal proteins, almond flour, coconut flour, buckwheat flour, teff flour, quinoa flour, corn flour, wheat flour, barley flour, rice flour, rye flour, tree sap, syrup, sugars, tars, nut shells, nut husks, corn husks, grass clippings, any by product from the production of rice, wheat, and other grain, ethylene glycol derivatives, ionic water, salt, acids, alkaline, alcohol, isopropyl alcohol, bleach, and biodegradable surfactants.

6. The cellulose-based monolithic structural webbing mixture of claim 1, wherein the sawdust comprises particulates of a certain size between microscopic to one inch.

7. A method comprising:
thoroughly hydrating cellulose fibers including sawdust as one of its components;
mixing clay and mineral particulates with a liquid to produce an emulsion;
adding the emulsion to the hydrated cellulose fibers; and
thoroughly coating and impregnating the cellulose fibers with components from the emulsion to mimic a petrification process without damaging lignin contained in the cellulose fibers to maintain the tensile, flexural, insulation and energy absorbing qualities of wood and producing an admix product.

8. The method of claim 7, further comprising:
combining the admix product with a certain quantity of aggregate, a certain quantity of cement and a certain quantity of a liquid;
thoroughly mixing and creating a activated structural webbing mixture; and
directly spraying the activated structural webbing mixture onto a structure.

9. The method of claim 6, comprising adding an additive is selected from the group consisting of sand, gravel, graphene, crystalline expander, carbon-based materials, silt, peat, loam, chalk, fly ash, recycled paper, phosphate, lime, calcium, magnesium, sugars, lignin, vegetable and animal proteins, almond flour, coconut flour, buckwheat flour, teff flour, quinoa flour, corn flour, wheat flour, barley flour, rice flour, rye flour, tree sap, syrup, sugars, tars, nut shells, nut husks, corn husks, grass clippings, any by product from the production of rice, wheat, and other grain, ethylene glycol derivatives, ionic water, salt, acids, alkaline, alcohol, isopropyl alcohol, bleach, and biodegradable surfactants.

10. A cellulose-based structural webbing material for spray-on applications comprising cellulose fibers under one inch in size, the cellulose fibers being thoroughly coated and impregnated with fine clay and mineral particulates that mimics a petrification process without damaging lignin contained in the sawdust to maintain the tensile, flexural, insulation and energy absorbing qualities of wood, the structural webbing mixture being adapted for incorporation with cement and water to produce an activated structural webbing product for spray-on applications to create a fire-proof insulative structural-reinforcing cementitious webbing envelope around building structures.

11. The cellulose-based structural webbing material of claim 10, wherein the cellulose fibers are thoroughly coated and impregnated with fine clay and mineral particulates by injecting an emulsion of fine clay and mineral particulates into a pressurized chamber containing hydrated cellulose fibers.

12. The cellulose-based structural webbing material of claim 10, wherein the cellulose fibers are thoroughly coated and impregnated with fine clay and mineral particulates by forcing raw clay particulates into hydrated cellulose fibers.

13. The cellulose-based structural webbing material of claim 10, wherein the activated structural webbing mixture further comprises cellulose fibers selected from the group consisting of sawdust, wood chips, wood flakes, wood strips, fiber, bamboo, hemp, burlap, tweed, organic waste, and animal waste.

14. The cellulose-based structural webbing material of claim 10, wherein the activated structural webbing mixture further comprises cement.

15. The cellulose-based structural webbing material of claim 10, wherein the activated structural webbing mixture further comprises cement and water.

16. The cellulose-based structural webbing material of claim 10, further comprising an additive selected from the group consisting of sand, gravel, graphene, crystalline expander, carbon-based materials, silt, peat, loam, chalk, fly ash, recycled paper, phosphate, lime, calcium, magnesium, sugars, lignin, vegetable and animal proteins, almond flour, coconut flour, buckwheat flour, teff flour, quinoa flour, corn flour, wheat flour, barley flour, rice flour, rye flour, tree sap, syrup, sugars, tars, nut shells, nut husks, corn husks, grass clippings, any by product from the production of rice, wheat, and other grain, ethylene glycol derivatives, ionic water, salt, acids, alkaline, alcohol, isopropyl alcohol, bleach, and biodegradable surfactants.
